(19) United States
(12) Patent Application Publication
(10) Pub. No.: US 2009/0128039 A1
(43) Pub. Date: May 21, 2009

(54) Discharge Lamp with Electrode Made Of Tungsten Alloy Comprising < 3 Wt.% Of Rhenium

(75) Inventors: Jiajun Wang, Maarheeze (NL); Ger Van Hees, Turnhout (BE); Wim Simons, Turnhout (BE); Albertus Reinders, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/912,340

(22) PCT Filed: Apr. 26, 2006
(86) PCT No.: PCT/IB06/51298

§ 371 Date: Oct. 23, 2007

(30) Foreign Application Priority Data
Apr. 27, 2005 (EP) 05103442.9

(51) Int. Cl. H01J 61/06

(52) U.S. Cl. 313/633

(57) ABSTRACT

The invention relates to a high-pressure gas discharge lamp (1) comprising a discharge chamber (4) with a gas filling and electrodes (5) disposed in the discharge chamber. At least one of said electrodes is a tungsten alloy electrode, where the alloy is made of (a) ultra-high pure tungsten and (b) at least one of rhenium, osmium, tantalum, hafnium, iridium, and zirconium in a quantity of 0.01 to 3% by weight of the quantity of tungsten. The tungsten alloy of the invention strikes an appropriate balance between a rhenium or osmium content, which is high enough to obtain sufficient ductility allowing wire processing, and low enough to reduce the amount of rhenium evaporation responsible for blackening the interior of the discharge chamber during operation of the lamp. The invention further relates to a method of manufacturing such a lamp.

### FIELD OF THE INVENTION

The invention relates to a high-pressure gas discharge lamp comprising a light-transmitting discharge vessel with a gas filling and electrodes disposed in the discharge vessel.

### BACKGROUND OF THE INVENTION

Because of their good lighting properties, high-pressure gas discharge lamps have become widely popular. These lamps generally comprise a discharge vessel having feedthroughs through which electrodes extend into the discharge vessel, or rather into the discharge chamber enclosed by the discharge vessel. When the lamp is in the operating state, an arc discharge is excited between the free ends of the electrodes.

The discharge chamber generally contains a gas filling (lamp filling) comprising a starter gas (such as, for example, argon), a discharge gas (such as, for example, one or more metal halides such as sodium iodide and/or scandium iodide), which forms the actual light-emitting material, and a voltage-gradient generator or buffer gas (such as mercury) whose principal function is to promote the evaporation of the light-producing substances by raising the temperature or pressure, and to increase the efficacy and burning voltage of the lamp.

As the electrodes of discharge lamps are exposed to severe conditions in operation of the lamps, heavy demands are made on the materials and structures of these electrodes.

EP-A 0 343 625 discloses an arc tube bulb comprising a sealed portion formed at one end of the bulb and an enclosure portion formed at the other end to surround a discharge space. A pair of metal foils is buried in the sealed portion. A rare gas for start-up, mercury and a metal halide are charged in the discharge space. A pair of electrodes comprises a pair of electrode rods connected to the metal foils and coils disposed at the tips of the rods. These coils are positioned within the discharge region apart from each other and facing each other. A rhenium-tungsten alloy may be used as a material for the rods. For such an alloy, a mixing ratio of rhenium to tungsten should be 0.05 or more by weight to reduce the risk of electrode breakage during operation.

A disadvantage of the tungsten-rhenium alloy electrode of the prior art is the likelihood of evaporation of considerable quantities of rhenium in operation of the lamp. This is particularly true for high temperatures, e.g. temperatures above 2800° C., which is the operation temperature of the electrodes of current discharge lamps. Evaporation of rhenium disturbs the lamp atmosphere and blackens the discharge chamber.

### OBJECT AND SUMMARY OF THE INVENTION

It is an object of the invention to provide a discharge lamp with an electrode having a considerable mechanical strength, both when processing the electrode and in operation of the lamp, and having a reduced blackening behavior.

This object is achieved by a high-pressure gas discharge lamp comprising a discharge chamber with a gas filling and electrodes disposed in the discharge chamber, wherein at least one of said electrodes is a tungsten alloy electrode consisting essentially of (a) ultra-high pure tungsten and (b) at least one of rhenium, osmium, tantalum, hafnium, iridium, and zirconium in a quantity of 0.01 to 3% by weight of the quantity of tungsten.

Ultra-high pure tungsten is a brittle and weak material, especially in an annealed state, which hinders electrode processing. Doping the tungsten material with e.g. rhenium (Re) to obtain a tungsten-rhenium alloy increases the ductility of the obtained alloy, which is advantageous for electrode processing, e.g. wire drawing and electrode shaping (such as grinding, welding) and also for the mechanical strength of the electrode in operation. The low quantity of rhenium reduces the blackening effect of the discharge chamber by the electrode. The low quantity of rhenium also reduces the effect of work-hardening during wire drawing and thus eliminates or reduces the necessity of additional annealing steps during wire drawing. Similar effects are expected for osmium. In conclusion, the tungsten alloy of the invention strikes an appropriate balance between e.g. a rhenium content, which is high enough to obtain sufficient ductility allowing electrode processing and reducing electrode breakage during the lamp lifetime, and low enough to reduce the amount of rhenium evaporation responsible for blackening the interior of the discharge chamber during operation of the lamp.

It is to be noted that ultra-high pure tungsten powder comprises at least 99.99% of tungsten atoms, preferably at least 99.999 or even 99.9999% of tungsten (apart from oxygen, carbon and nitrogen). The powder used for making the alloy comprises at least 0.01% by weight (apart from oxygen, carbon and nitrogen) of component (b), which is selected from rhenium, osmium, tantalum, hafnium, iridium and zirconium. Component (b) comprises at least 50% by weight of rhenium or osmium, or a mixture thereof. Up to 50% by weight of component (b) may be tantalum, and up to 10% by weight of component (b) may be at least one of hafnium, iridium and zirconium.

Furthermore, it should be noted that the electrode may comprise small quantities of impurities or additives, introduced e.g. with the powders. In an embodiment of the invention, the impurities account for no more than 10 μg/g of the electrode, preferably not more than 5 μg/g of the electrode, most preferably not more than 1 μg/g of the electrode. The small quantity of impurities or additives allows obtaining appropriate mechanical characteristics for the electrode with a small quantity of component (b).

It should be appreciated that the quantity of oxygen, carbon or nitrogen depends largely on surface absorption. Preferably, these constituents do not account for more than 30 μg/g of the electrode. The quantity of oxygen, carbon and/or nitrogen is not taken into account in the definitions of the quantities of the alloy constituents for use in the electrode.

In a preferred embodiment, the tungsten alloy electrode comprises a rod and a coil wound around said rod. This structure of the electrode provides an adequate heat distribution on the electrode. The rod may consist of the alloy according to the invention and is annealed at a high temperature, e.g. higher than 2000° C., in dry hydrogen to remove impurities. The wire used for the coil has preferably not been annealed, because an annealed wire may be too brittle to form a coil. After the rod and the coil have been assembled, the assembled electrode may be annealed at a high temperature, e.g. higher than 2000° C.

In an embodiment of the invention, at least a portion of the electrode has a temperature in the range of 2800 to 3400° C. during operation of the lamp. The reduction of blackening by the electrode is particularly noticeable in this temperature range.

In an embodiment of the invention, the discharge lamp is a high-pressure metal halide lamp. In operation, the electrodes, or portions thereof, in such lamps heat to particularly high temperatures. Consequently, use of the tungsten alloy of the invention facilitates processing of the electrodes while the amount of rhenium evaporation, even in the high temperature range, is reduced.

The invention also relates to a method of manufacturing a high-pressure gas discharge lamp or an electrode or a portion of an electrode for such a high-pressure gas discharge lamp, the method comprising the step of applying and/or preparing a tungsten alloy electrode consisting essentially of (a) ultra-high pure tungsten and (b) at least one of rhenium, osmium, tantalum, hafnium, iridium, and zirconium in a quantity of 0.01 to 3% by weight of the quantity of tungsten. In an embodiment of the invention, the impurities account for no more than 10 μg/g of the electrode, preferably not more than 5 μg/g of the electrode, most preferably not more than 1 μg/g of the electrode. The small quantity of impurities or additives allows obtaining appropriate mechanical characteristics for the electrode with a small quantity of component (b). Preferably, the method involves the step of drawing a wire from said tungsten alloy and annealing said wire at a temperature in a temperature range of 2000 to 2500° C. to reduce the quantity of impurities.

The tungsten alloy of the invention strikes an appropriate balance between e.g. a rhenium content, which is high enough to obtain sufficient ductility allowing electrode processing and to provide sufficient mechanical stability during operation, and low enough to reduce the amount of rhenium evaporation responsible for blackening the interior of the discharge chamber during operation of the lamp.

It is to be noted that JP-A-09 231939 discloses a high melting-point metal electrode with a rhenium tungsten portion made of tungsten to which a rhenium element is added in the range of 0.1 to 25% by weight. However, only the tip of the anode instead of the complete electrode is made of this alloy. Furthermore, the largest portion of the range specified for the rhenium quantity would by far result in unallowable blackening of the interior of the lamp.

Tungsten-rhenium alloys are known to be used in incandescent lamps. U.S. Pat. No. 4,413,205 discloses a halogen incandescent lamp having current conductors substantially of tungsten containing at least 0.1% by weight of rhenium. However, incandescent lamps operate at lower temperatures than discharge lamps and, consequently, blackening effects and release of impurities occur to a much lesser extent. The low rhenium content is only chosen for reasons of cost, as mentioned explicitly in U.S. Pat. No. 4,413,205. Moreover, the tungsten material of conventional incandescent lamps contains a considerably larger quantity of impurities than the ultra-high pure tungsten used for the discharge lamp of the invention. Consequently, the claimed rhenium quantity would be too low to significantly improve the mechanical properties of such less pure tungsten electrodes.

The invention will be further illustrated with reference to the accompanying drawings, which schematically show preferred embodiments according to the invention. It will be understood that the invention is not limited in any way to these specific and preferred embodiments.

### BRIEF DESCRIPTION OF THE DRAWINGS

In the drawings:

FIG. 1 is a cross-sectional view of a metal halide high-intensity discharge lamp according to an embodiment of the present invention;

FIGS. 2A and 2B show measurement results of ultimate tensile strength tests of tungsten-rhenium alloys after annealing at various temperatures, and

FIGS. 3A-3C illustrate the effect of rhenium on the microstructure of a tungsten-rhenium alloy in an as-deformed state (FIG. 3A) and an annealed state (FIGS. 3B and 3C).

### DESCRIPTION OF EMBODIMENTS

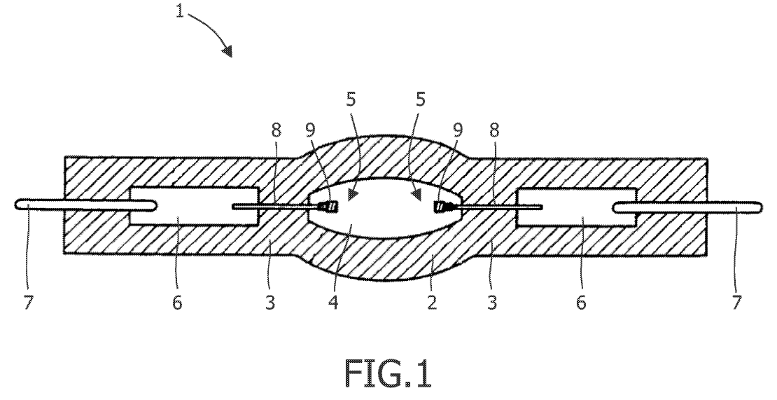

FIG. 1 is a cross-sectional view of a metal halide high-intensity discharge lamp 1 according to an embodiment of the present invention. The lamp 1 has a sealed light-transmitting discharge vessel 2 of quartz glass, i.e. glass having a SiO₂ content of at least 95% by weight, but may alternatively be of a mono or polycrystalline ceramic material, which has opposite seals 3 and envelopes a discharge chamber 4. Ceramic vessels typically are not pinch-sealed but contain a ceramic plug. The lamp shown in FIG. 1 is an AC-lamp, but DC-lamps also fall within the scope of the present invention. The discharge chamber 3 has a gas filling comprising rare gas and metal halides. As an example, the discharge chamber 4 may be filled with 0.87 mg Nal, 0.45 mg SnI2, 0.76 mg NaBr, 0.21 mg TlBr, 0.17 mg HgI2, 2666 Pa O2, 44 mg Hg and 10 000 Pa Ar. When the lamp is switched on, the oxygen reacts to form oxyhalides.

Electrodes 5 are oppositely disposed in the discharge chamber 4. Current feedthrough conductors are located in a respective seal 3 of the discharge vessel 2 and issue from the discharge vessel 2. In the present example, each current feedthrough conductor is composed of a metal foil 6, e.g. of molybdenum, which is fully located inside a respective seal 3, and of a metal rod 7, e.g. of molybdenum, which projects from the discharge vessel 1. Electrode rods 8 of drawn wire are connected to a respective one of said metal foils 6 by welding them to these metal foils 6 and enter the discharge chamber 4 and carry a respective one of said electrodes 5. The electrode rods 8 carry wound coils 9 disposed at the distal portion of the rods 8 within the discharge chamber 4.

According to an aspect of the invention, the electrodes 5 are formed of a tungsten-rhenium alloy comprising ultra-high pure tungsten and rhenium in a quantity of 0.01 to 3% by weight, preferably 0.1 to 1% by weight. Advantageous examples include 0.2% or 0.5% by weight of rhenium. The ultra-high pure tungsten contains 99.999% of tungsten.

Doping the tungsten material with rhenium to obtain a tungsten-rhenium alloy increases the ductility of the obtained alloy, which is advantageous for electrode processing, e.g. wire drawing, electrode shaping and assembling, and also for the mechanical strength of the electrode 5 in operation. The low quantity of rhenium reduces the blackening effect of the discharge chamber 4 by the electrode 5.

The processing operations for making the rod 8 and coils 9 are substantially the same. First, powder processing is performed to obtain a mixture of ultra-high pure tungsten and the desired quantity of rhenium. The green product is subsequently pressed and sintered at a temperature between 2700 and 3200° C. After rolling and swaging, a wire is drawn. To manufacture the rod 8, the wire is annealed at a high temperature, e.g. higher than 2000° C., in dry hydrogen to remove impurities. The wire used for the coil 9 is preferably not annealed.

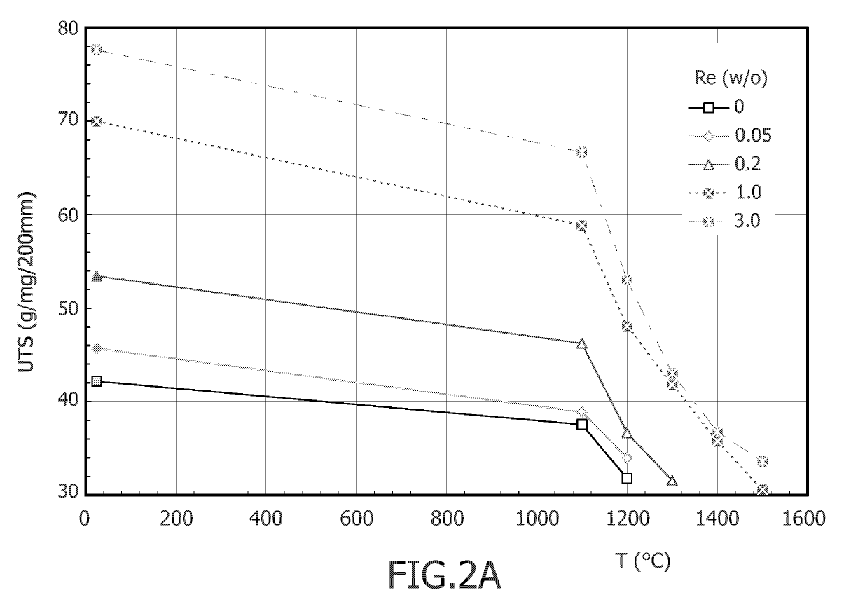

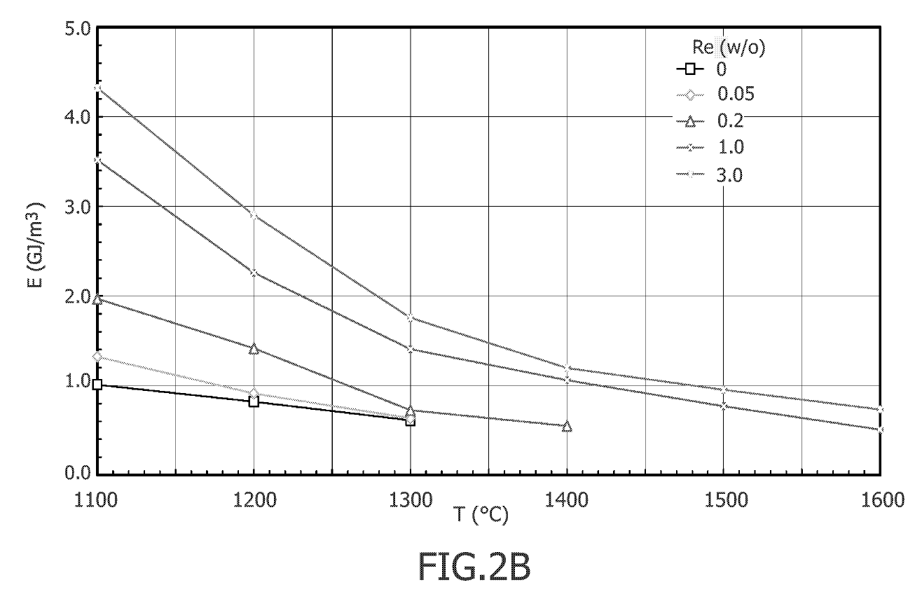

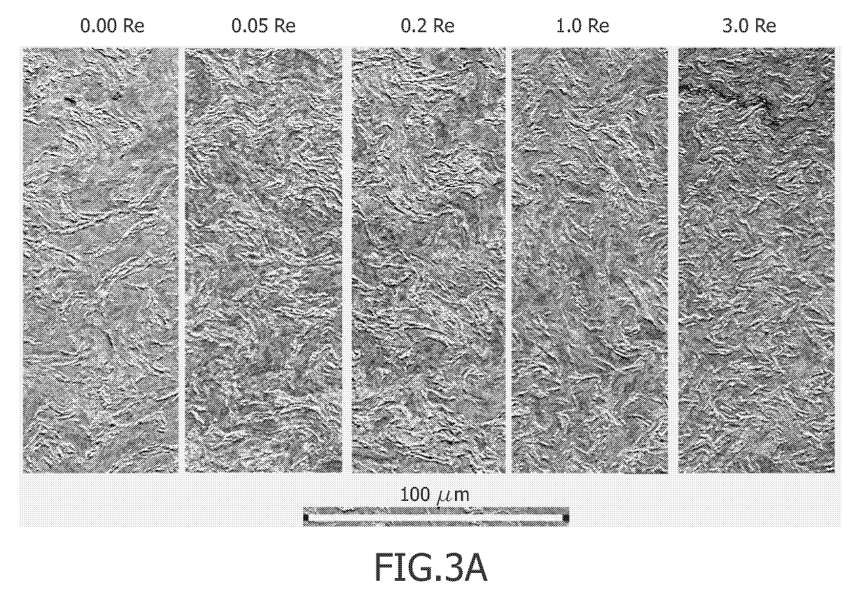

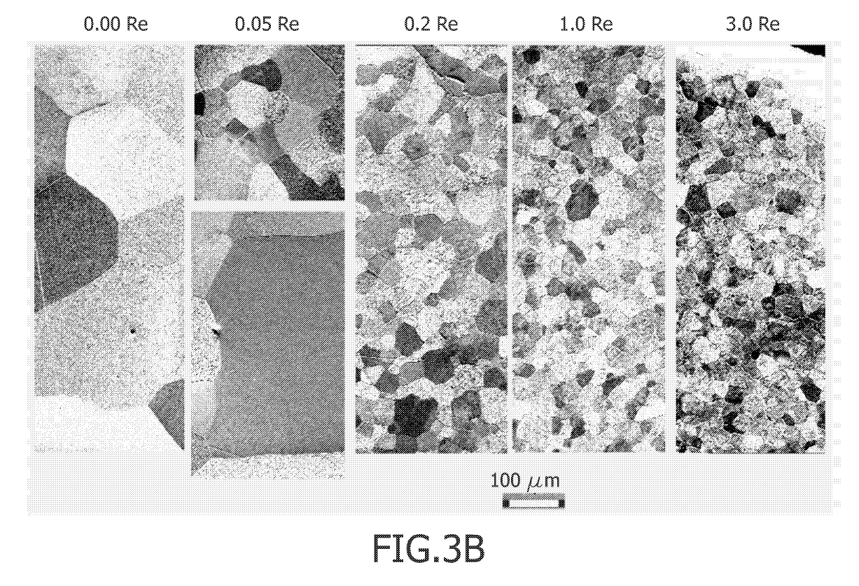

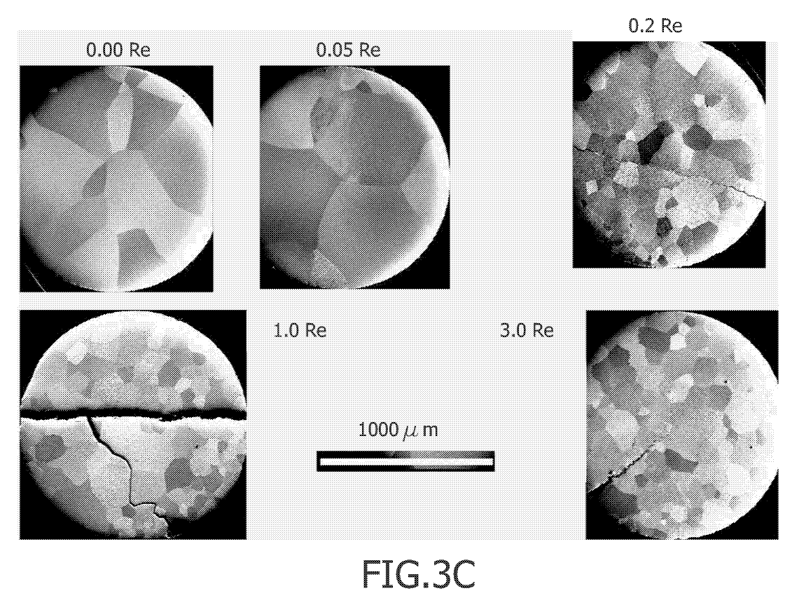

FIGS. 2A and 2B and 3A-3C show experimental results of tests of the tungsten-rhenium alloy after annealing. The unit of the vertical axis of FIG. 2A is the force in grams divided by the weight of a piece of wire with a length of 200 mm.

FIG. 2A shows the ultimate tensile strength (UTS) of ultra-high pure tungsten rods with a diameter of 175 μm and doped with different quantities of rhenium ranging between 0 and 3% by weight and annealed at different temperatures between 1100° C. and 1500° C. The points corresponding to a temperature of 25° C. represent the values of the UTS in the as-deformed state, i.e. after drawing of the wire. Clearly, the UTS increases continuously with the rhenium content, regardless of the annealing temperature. In conclusion, alloying the ultra-high pure tungsten with rhenium significantly strengthens the wire. The effect becomes already noticeable at a rhenium quantity of 0.05% by weight. FIG. 2B shows results for the ductility E of the wire, which may be derived from the UTS tests by the formula

E[GJ·m⁻³]=UTS·εₘₐₓ

wherein εₘₐₓ is the homogeneous elongation of the wire. The ductility improves with the quantity of rhenium, which is advantageous for wire processing. Drawing of the wire is typically performed at temperatures below 1600° C.

FIGS. 3A-3C show images of the microstructure of ultra-high tungsten wires with a diameter of 1310 μm doped with rhenium quantities of 0%, 0.05%, 0.2%, 1% and 3% by weight.

FIG. 3A shows the as-deformed microstructure. The effect of rhenium is not visible as a result of the strong deformation effect of the wire drawing.

FIG. 3B shows the microstructure after annealing the samples at 2000° C. for 10 minutes in a dry hydrogen atmosphere. Clearly, the addition of only 0.2% by weight of rhenium is sufficient to obtain a fine microstructure, i.e. reduction of the grain size. A finer grain size is indicative of a higher ductility.

FIG. 3C shows pictures of the microstructure of samples annealed at 2500° C. The effect of the rhenium addition remains in samples containing more the 0.2% by weight of rhenium.

Accordingly, it is concluded that, during operation, the ductility of the tungsten-rhenium electrode 5 of the invention is considerably improved by low quantities of rhenium.

Although the addition of rhenium continuously improves the mechanical performance of the wires, which is advantageous when processing the electrodes 5, the rhenium quantity, in an aspect of the invention, is limited to 3% by weight, preferably 1% by weight, to reduce the amount of rhenium evaporation resulting in blackening of the interior of the lamp 1. Furthermore, wires with high quantities of rhenium, e.g. more than 1% by weight, show considerable work-hardening during wire drawing and would require additional annealing steps. The low quantity of rhenium avoids or reduces the need for such additional steps.

In the claims, any reference sign placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The mere fact that certain measures are recited in mutually different dependent claims does not indicate that a combination of these measures cannot be used to advantage.

1. A high-pressure gas discharge lamp (1) comprising a discharge chamber (4) with a gas filling and electrodes (5) disposed in the discharge chamber, wherein at least one of said electrodes is a tungsten alloy electrode consisting essentially of (a) ultra-high pure tungsten and (b) at least one of rhenium, osmium, tantalum, hafnium, iridium, and zirconium in a quantity of 0.01 to 3% by weight of the quantity of tungsten.

2. The discharge lamp (1) according to claim 1, wherein said tungsten alloy electrode has less than 10 μg per gram of said alloy of impurities apart from oxygen, carbon and nitrogen.

3. The discharge lamp (1) according to claim 1, wherein said tungsten alloy electrode (5) comprises component (b) in a quantity of 0.1 to 1% by weight.

4. The discharge lamp (1) according to claim 1, wherein component (b) consists of 50 to 100% by weight of rhenium and/or osmium, 0 to 50% by weight of tantalum, and 0 to 10% by weight of at least one of hafnium, iridium and zirconium, up to a total of 100% by weight.

5. The discharge lamp (1) according to claim 1, wherein said tungsten alloy electrode (5) comprises a rod (8) and a coil (9) wound around said rod.

6. The discharge lamp (1) according to claim 1, wherein at least a portion of said electrode (5) has a temperature in the range of 2800 to 3400° C. during operation.

7. The discharge lamp (1) according to claim 1, wherein said discharge lamp is a high-pressure metal halide lamp.

8. A method of manufacturing a high-pressure gas discharge lamp (1) or an electrode (5) or a portion of an electrode for such a high-pressure gas discharge lamp, the method comprising the step of applying and/or preparing a tungsten alloy electrode consisting essentially of (a) ultra-high pure tungsten and (b) at least one of rhenium, osmium, tantalum, hafnium, iridium, and zirconium in a quantity of 0.01 to 3% by weight of the quantity of tungsten.

9. The method of claim 8, wherein said tungsten alloy electrode has less than 10 μg per gram of said alloy of impurities apart from oxygen, carbon and nitrogen.

10. The method according to claim 8, comprising the step of drawing a wire from said tungsten alloy and annealing said wire at a temperature in a temperature range of 2000 to 2500° C.
